(19) United States
(12) Patent Application Publication
(10) Pub. No.: US 2022/0194372 A1
(43) Pub. Date: Jun. 23, 2022

(54) VEHICLE CONTROL SYSTEM AND VEHICLE CONTROL METHOD

(71) Applicant: Panasonic Intellectual Property Management Co., Ltd., Osaka (JP)

(72) Inventors: Nobutaka KITAJIMA, Osaka (JP); Kyoko UEDA, Osaka (JP); Mutsumi KAWAGOE, Osaka (JP); Tadashi YOSHIDA, Osaka (JP); Masakazu NAKAZAWA, Osaka (JP); Yasuhiro ITO, Osaka (JP); Kenji OGA, Osaka (JP)

(73) Assignee: Panasonic Intellectual Property Management Co., Ltd., Osaka (JP)

(21) Appl. No.: 17/544,346

(22) Filed: Dec. 7, 2021

(30) Foreign Application Priority Data
Dec. 22, 2020 (JP) 2020-212929

(51) Int. Cl. B60W 30/14; B60W 30/16; B60W 30/18; B60W 40/02; G06V 20/56; G06V 20/58

(52) U.S. Cl. CPC B60W 30/143; B60W 30/16; B60W 30/18163; B60W 40/02; G06V 2201/08; G06V 20/58; B60W 2554/4045; B60W 2554/80; B60W 2555/20; G06V 20/588

(57) ABSTRACT

A vehicle control system includes a camera that detects a merging lane that exists in front of the host vehicle that is traveling and merges with a traveling lane, and a controller that controls the traveling of the host vehicle to change lanes from the traveling lane to an overtaking lane.

### CROSS REFERENCE TO RELATED APPLICATION

The present application is based on and claims priority of Japanese Patent Application No. 2020-212929 filed on December 22, 2020.

### FIELD

This disclosure relates to a vehicle control system and a vehicle control method.

### BACKGROUND

A so-called adaptive cruise control system (hereinafter referred to as “ACC system”) that controls the traveling speed of the own vehicle so as to keep the inter-vehicle distance between the own vehicle and the preceding vehicle constant is known.

In the vehicle control system disclosed in Patent Literature 1 (PTL 1), when the host vehicle equipped with the ACC system is traveling in the main lane of the expressway, based on the traveling speed and position of one merging vehicle merging from the on-ramp of the highway, the traveling speed of the host vehicle is controlled so that the one merging vehicle can merge into the main lane.

### CITATION LIST

### Patent Literature

PTL 1: Japanese Patent No. 6353525

### SUMMARY

However, the vehicle control device according to PTL 1 can be improved upon.

In view of this, the present disclosure provides a vehicle control device and a vehicle control method that are capable of improving upon the above related art.

The vehicle control system according to one aspect of the present disclosure is a vehicle control system that controls traveling of a host vehicle traveling in a first main lane, the vehicle control system including: a merging lane detector that detects a merging lane that merges with the first main lane, the merging lane existing in front of the host vehicle that is traveling; and a controller that controls the traveling of the host vehicle to change lanes from the first main lane to a second main lane different from the first main lane when the merging lane is detected by the merging lane detector.

It should be noted that these comprehensive or specific aspects may be realized by a system, a method, an integrated circuit, a computer program, or a recording medium such as a computer-readable compact disc-read only memory (CD-ROM), and may be realized by any combination of a system, a method, an integrated circuit, a computer program and a recording medium.

A vehicle control system according to one aspect of the present disclosure is capable of improving upon the above related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a block diagram showing a configuration of a vehicle control system according to an embodiment.

FIG. 2 is a flowchart showing a flow of Operation Example 1 of the vehicle control system according to the embodiment.

FIG. 3 is a diagram for explaining Operation Example 1 of the vehicle control system according to the embodiment.

FIG. 4 is a flowchart specifically showing a process flow of step S109 of the flowchart in FIG. 2.

FIG. 5 is a diagram for explaining the process of step S204 of the flowchart in FIG. 4.

FIG. 6 is a diagram for explaining the process of step S207 of the flowchart of FIG. 4.

FIG. 7 is a flowchart showing a flow of Operation Example 2 of the vehicle control system according to the embodiment.

FIG. 8 is a diagram for explaining Operation Example 2 of the vehicle control system according to the embodiment.

FIG. 9 is a flowchart showing a flow of Operation Example 3 of the vehicle control system according to the embodiment.

FIG. 10 is a diagram for explaining Operation Example 3 of the vehicle control system according to the embodiment.

FIG. 11 is a flowchart showing a flow of Operation Example 4 of the vehicle control system according to the embodiment.

FIG. 12 is a diagram for explaining Operation Example 4 of the vehicle control system according to the embodiment.

FIG. 13 is a flowchart showing a flow of Operation Example 5 of the vehicle control system according to the embodiment.

FIG. 14 is a diagram for explaining Operation Example 5 of the vehicle control system according to the embodiment.

FIG. 15 is a flowchart showing a flow of Operation Example 6 of the vehicle control system according to the embodiment.

### DESCRIPTION OF EMBODIMENT

### (Underlying Knowledge Forming Basis of the Present Disclosure)

The present inventors have found that the following problem occurs with respect to the vehicle control system described in the “Background” section.

In the vehicle control system of PTL 1 described above, when the traveling speed of the host vehicle is controlled, only the traveling speed and position of one merging vehicle are taken into consideration, so that it cannot be said that the traveling safety of the host vehicle is sufficiently guaranteed.

In order to solve such a problem, the vehicle control system according to one aspect of the present disclosure is a vehicle control system that controls traveling of a host vehicle traveling in a first main lane, the vehicle control system including: a merging lane detector that detects a merging lane that merges with the first main lane, the merging lane existing in front of the host vehicle that is traveling; and a controller that controls the traveling of the host vehicle to change lanes from the first main lane to a second main lane different from the first main lane when the merging lane is detected by the merging lane detector.

According to the present aspect, the controller controls the traveling of the host vehicle to change lanes from the first main lane to the second main lane when the merging lane is detected by the merging lane detector. Accordingly, for example, even when a merging vehicle from the merging lane merges into the first main lane, it is possible to make the host vehicle change lanes at an appropriate timing with a margin. As a result, the traveling safety of the host vehicle can be improved.

For example, the vehicle control system may be configured such that the merging lane includes a first merging lane and a second merging lane that is adjacent to the first merging lane, the vehicle control system further comprises a merging vehicle detector that detects one or more merging vehicles traveling in at least one of the first merging lane or the second merging lane, and the controller further controls the traveling of the host vehicle to allow the one or more merging vehicles to merge into the first main lane based on a detection result of the merging vehicle detector.

According to the present aspect, when one or more merging vehicles are traveling in at least one of the first merging lane or the second merging lane, it is possible to control the traveling of the host vehicle appropriately so that the one or more merging vehicles are capable of merging in the first main lane by considering a detection result of the merging vehicle detector.

For example, the vehicle control system may be configured such that the vehicle control system further includes a merging vehicle detector that detects a merging vehicle traveling in the merging lane, wherein when a plurality of the merging vehicles are detected by the merging vehicle detector, the controller further controls the traveling of the host vehicle so that the plurality of merging vehicles are capable of merging in the first main lane based on a detection result of the merging vehicle detector.

According to the present aspect, when a plurality of merging vehicles are traveling in the merging lane, it is possible to control the traveling of the host vehicle appropriately so that the plurality of merging vehicles are capable of merging in the first main lane by considering a detection result of the merging vehicle detector.

For example, the vehicle control system may be configured such that the vehicle control system further includes a merging vehicle detector that detects a merging vehicle traveling in the merging lane, wherein the controller further determines whether the merging vehicle intends to merge into the first main lane based on a detection result of the merging vehicle detector, and controls the traveling of the host vehicle based on a result of determining whether the merging vehicle intends to merge.

According to the present aspect, it is possible to control the traveling of the host vehicle appropriately by considering the presence or absence of the intention of the merging vehicle to merge into the first main lane.

For example, the vehicle control system may be configured such that the vehicle control system further includes a merging vehicle detector that detects a merging vehicle traveling in the merging lane, wherein the controller further determines a type of the merging vehicle based on a detection result of the merging vehicle detector, and controls the traveling of the host vehicle so that the merging vehicle is capable of merging in the first main lane based on the type of the merging vehicle determined. According to the present aspect, it is possible to control the traveling of the host vehicle appropriately so that the merging vehicle is capable of merging in the first main lane by considering the type of the merging vehicle.

For example, the vehicle control system may be configured such that the vehicle control system further includes a traveling environment detector that detects a traveling environment of the host vehicle, and the controller further controls the traveling of the host vehicle based on a detection result of the traveling environment detector.

According to the present aspect, it is possible to control the traveling of the host vehicle appropriately by considering the traveling environment of the host vehicle.

For example, the vehicle control system may be configured such that the controller determines whether the host vehicle is in front of the merging vehicle that is traveling at a predicted merging time when the merging vehicle is predicted to reach a merging point of the merging lane and the first main lane, and increases a vehicle speed of the host vehicle when the host vehicle is in front of the merging vehicle that is traveling.

According to the present aspect, it is possible to secure a sufficient inter-vehicle distance between the host vehicle and the merging vehicle while the host vehicle is traveling in front of the merging vehicle that is traveling at the predicted merging time.

For example, the vehicle control system may be configured such that the controller determines whether the host vehicle is in front of the merging vehicle that is traveling at a predicted merging time when the merging vehicle is predicted to reach a merging point of the merging lane and the first main lane, and reduces a vehicle speed of the host vehicle when the host vehicle is behind the merging vehicle that is traveling.

According to the present aspect, it is possible to secure a sufficient inter-vehicle distance between the host vehicle and the merging vehicle while the host vehicle is traveling behind the merging vehicle that is traveling at the predicted merging time.

The vehicle control method according to one aspect of the present disclosure is a vehicle control method for controlling traveling of a host vehicle traveling in a first main lane, the vehicle control method including: detecting a merging lane existing in front of the host vehicle that is traveling and merging with the first main lane, and controlling the traveling of the host vehicle to change lanes from the first main lane to a second main lane different from the first main lane when the merging lane is detected in the detecting.

According to the present aspect, when a merging lane is detected, the traveling of the host vehicle is controlled so as to change lanes from the first main lane to the second main lane. Accordingly, for example, even when a merging vehicle from the merging lane merges into the first main lane, it is possible to make the host vehicle change lanes at an appropriate timing with a margin. As a result, the traveling safety of the host vehicle can be improved.

It should be noted that these comprehensive or specific aspects may be realized by a system, a method, an integrated circuit, a computer program, or a recording medium such as a computer-readable compact disc-read only memory (CD-ROM), and may be realized by any combination of a system, a method, an integrated circuit, a computer program and a recording medium.

Hereinafter, the embodiment will be specifically described with reference to the drawings.

It should be noted that all of the embodiments described below show comprehensive or specific examples. The numerical values, shapes, materials, components, arrangement positions and connection forms of the components, steps, the order of steps, and the like shown in the following embodiments are examples, and are not intended to limit the present disclosure. In addition, among the components in the following embodiments, the components not described in the independent claims indicating the broadest concept are described as arbitrary components.

### Embodiment

### [1. Configuration of Vehicle Control System]

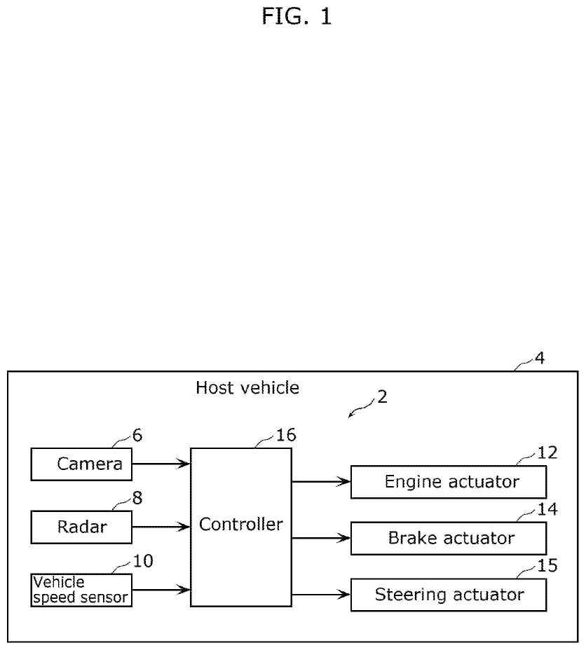

First, the configuration of vehicle control system 2 according to an embodiment will be described with reference to FIG. 1. FIG. 1 is a block diagram showing a configuration of vehicle control system 2 according to the embodiment.

As shown in FIG. 1, vehicle control system 2 is a system for controlling the traveling of host vehicle 4 such as an automobile, and is mounted on host vehicle 4. Vehicle control system 2 includes camera 6, radar 8, vehicle speed sensor 10, engine actuator 12, brake actuator 14, steering actuator 15, and controller 16.

Camera 6 is disposed, for example, on a rear-view mirror in the vehicle interior of host vehicle 4 and captures images in front of host vehicle 4 that is traveling. Here, “in front of host vehicle 4 that is traveling” includes not only the advancing direction of host vehicle 4 but also a range having a predetermined left-right spread around the advancing direction. Camera 6 outputs the image information captured in front of host vehicle 4 that is traveling to controller 16 as a detection result.

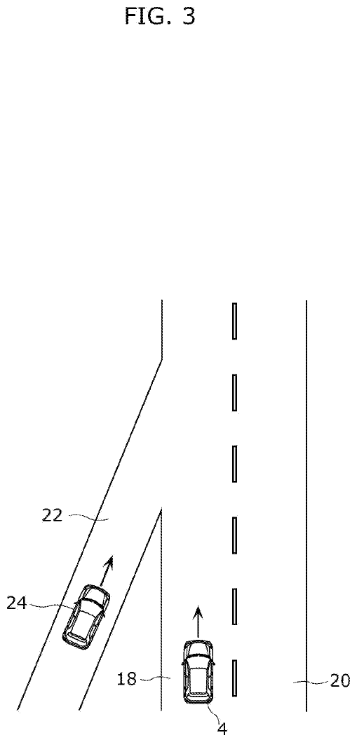

It should be noted that camera 6 is an example of a merging lane detector that detects merging lane 22 (see FIG. 3 described later) existing in a traveling forward direction of host vehicle 4. In addition, camera 6 is an example of a merging vehicle detector that detects merging vehicle 24 (see FIG. 3 described later) traveling in merging lane 22. Furthermore, camera 6 is an example of a traveling environment detector that detects the traveling environment of host vehicle 4.

Radar 8 is disposed, for example, on the front bumper of host vehicle 4, and outputs radio waves toward a traveling forward direction of host vehicle 4. Radar 8 outputs the target information, which indicates that an object exists in the traveling forward direction of host vehicle 4, to controller 16 as a detection result by receiving the reflected waves that the output radio waves are reflected by the object existing in the traveling forward direction of host vehicle 4. It should be noted that radar 8 is an example of a merging vehicle detector that detects merging vehicle 24 traveling in merging lane 22.

Vehicle speed sensor 10 detects the vehicle speed (traveling speed) of host vehicle 4 and outputs vehicle speed information indicating the detected vehicle speed to controller 16 as a detection result.

Engine actuator 12 is an actuator for accelerating host vehicle 4, and includes, for example, a throttle valve actuator for changing the opening degree of the throttle valve of the internal combustion engine. Engine actuator 12 increases the torque generated by the internal combustion engine by increasing the opening degree of the throttle valve of the internal combustion engine according to the control signal from controller 16.

Brake actuator 14 is an actuator for decelerating host vehicle 4. Brake actuator 14 adjusts the hydraulic pressure supplied to the wheel cylinder built in the brake caliper according to the control signal from controller 16, and presses the brake pad against the brake disc by the hydraulic pressure to generate a friction braking force.

Steering actuator 15 controls each steering angle of the left and right front wheels of host vehicle 4 according to the control signal from controller 16.

Controller 16 is an electronic control unit (ECU) for controlling the automatic driving operation of host vehicle 4 in the advanced driver assistance system (ADAS). Specifically, controller 16 controls, for example, acceleration and deceleration, steering, braking, and the like of host vehicle 4. It should be noted that the advanced driver support system includes an ACC system that automatically accelerates and decelerates host vehicle 4 according to the inter-vehicle distance, vehicle speed, and the like.

Controller 16 can communicate with camera 6, radar 8, vehicle speed sensor 10, engine actuator 12, brake actuator 14, and steering actuator 15 via the controller area network (CAN) bus.

Controller 16 controls engine actuator 12, brake actuator 14, and steering actuator 15 based on the detection results from camera 6, radar 8, and vehicle speed sensor 10.

For example, controller 16 compares the current vehicle speed indicated by the vehicle speed information from vehicle speed sensor 10 with a preset target speed as a function of keeping the vehicle speed of the ACC system constant. When the current vehicle speed is lower than the target speed, controller 16 controls engine actuator 12 to increase the torque generated by the internal combustion engine. Accordingly, host vehicle 4 accelerates until the vehicle speed of host vehicle 4 reaches the target speed. On the other hand, when the current vehicle speed is higher than the target speed, controller 16 controls brake actuator 14 to generate a braking force in host vehicle 4. Accordingly, host vehicle 4 decelerates until the vehicle speed of host vehicle 4 reaches the target speed. Other functions of controller 16 will be described later.

### [2. Operation of Vehicle Control System]

### [2-1. Operation Example 1]

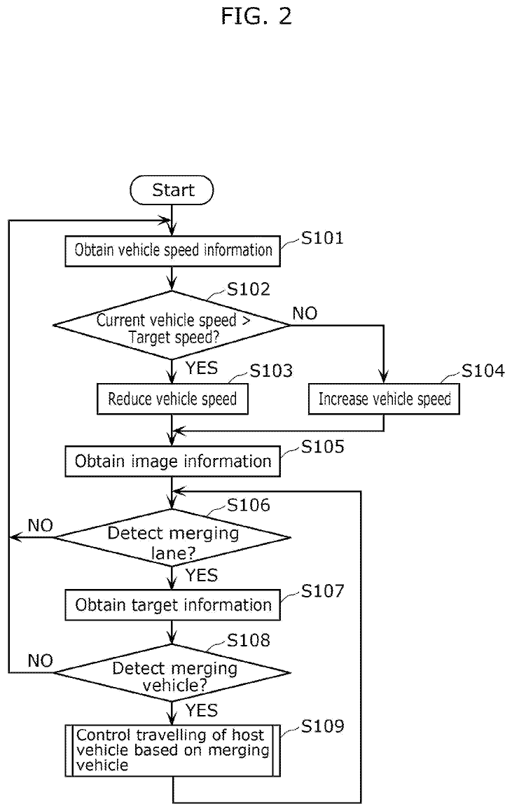

Operation Example 1 of vehicle control system 2 according to the embodiment will be described with reference to FIG. 2 and FIG. 3. FIG. 2 is a flowchart showing a flow of Operation Example 1 of vehicle control system 2 according to the embodiment. FIG. 3 is a diagram for explaining Operation Example 1 of vehicle control system 2 according to the embodiment.

In Operation Example 1, as shown in FIG. 3, a situation in which host vehicle 4 is traveling in traveling lane 18 (an example of the first main lane), which is the main lane of the expressway, by automatic driving will be described. It should be noted that overtaking lane 20 (an example of the second main lane), which is the main lane of the expressway different from traveling lane 18, is adjacent to the right side of traveling lane 18. In addition, merging lane 22, which is an on-ramp of the expressway, merges with traveling lane 18. Merging vehicle 24 such as an automobile is traveling in merging lane 22.

As shown in FIG. 2, first, controller 16 obtains vehicle speed information from vehicle speed sensor 10 (S101), and determines whether the current vehicle speed indicated by the obtained vehicle speed information is higher than the target speed. (S102).

When the current vehicle speed is higher than the target speed (YES in S102), controller 16 reduces the vehicle speed of host vehicle 4 by controlling brake actuator 14 (S103). On the other hand, in step S102, when the current vehicle speed is lower than the target speed (NO in S102), controller 16 increases the vehicle speed of host vehicle 4 by controlling engine actuator 12 (S104). It should be noted that the above steps S101 to S104 are processes for realizing the function of keeping the vehicle speed of the ACC system constant.

After step S103 or step S104, controller 16 obtains image information from camera 6 (S105) and detects the presence or absence of merging lane 22 in the traveling forward direction of host vehicle 4 by analyzing the obtained image information (S106). If merging lane 22 is not detected in the traveling forward direction of host vehicle 4 (NO in S106), the process returns to step S101.

On the other hand, in step S106, when merging lane 22 is detected in the traveling forward direction of host vehicle 4 as in the situation shown in FIG. 3 (YES in S106), controller 16 receives the target information from radar 8 (S107). Controller 16 detects the presence or absence of merging vehicle 24 in merging lane 22 by analyzing the obtained target information (S108). If merging vehicle 24 is not detected in merging lane 22 (NO in S108), the process returns to step S101.

On the other hand, in step S108, when merging vehicle 24 is detected in merging lane 22 (YES in S108) as in the situation shown in FIG. 3, controller 16 controls the traveling of host vehicle 4 based on the detected merging vehicle 24 (S109). After that, the process returns to step S106.

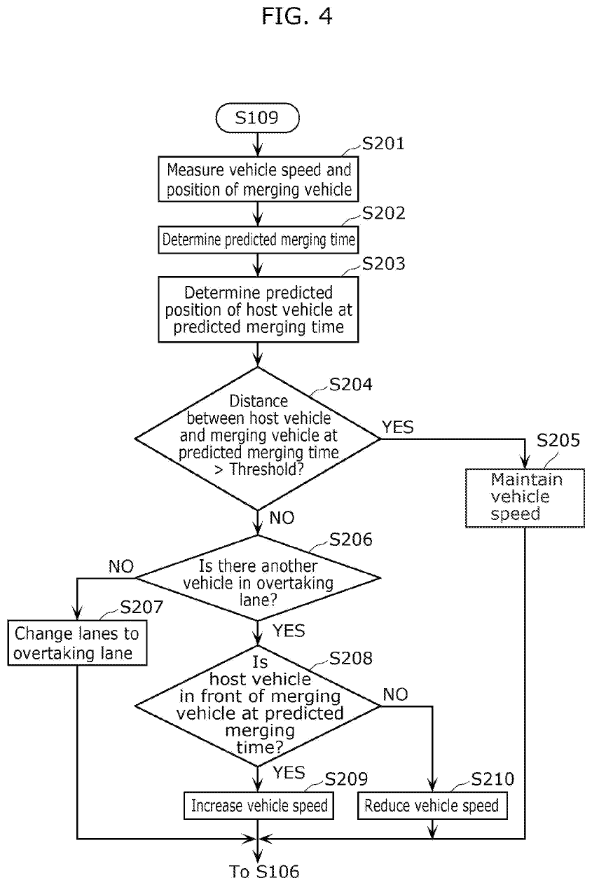

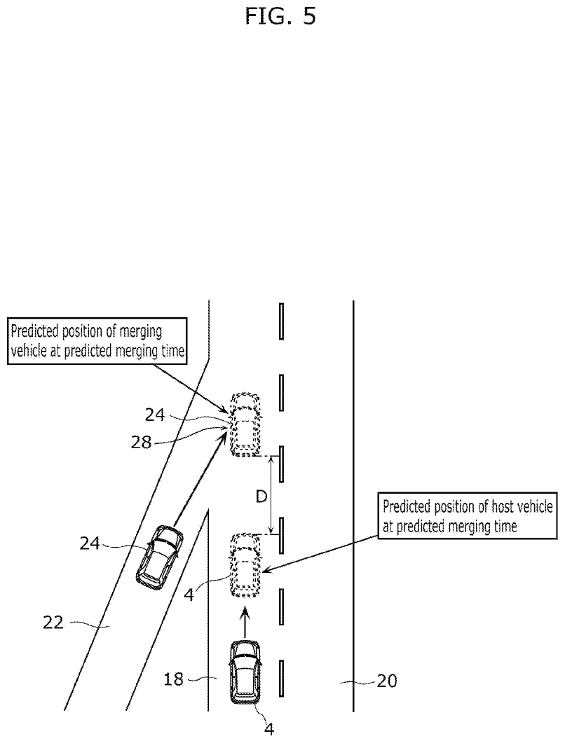

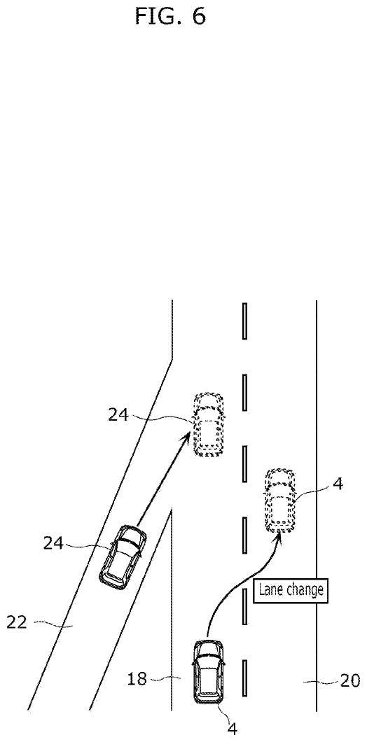

Next, the process of step S109 described above will be specifically described with reference to FIG. 4 to FIG. 6. FIG. 4 is a flowchart specifically showing the processing flow of step S109 of the flowchart of FIG. 2. FIG. 5 is a diagram for explaining the process of step S204 in the flowchart of FIG. 4. FIG. 6 is a diagram for explaining the process of step S207 in the flowchart of FIG. 4.

As shown in FIG. 4, controller 16 measures the vehicle speed and position of merging vehicle 24 based on the target information from radar 8 (S201). Here, the vehicle speed and position of merging vehicle 24 are, for example, the relative speed and relative position of merging vehicle 24 with respect to host vehicle 4. Based on the measured vehicle speed and position of merging vehicle 24, controller 16 determines the predicted merging time which is a time when merging vehicle 24 is predicted to reach merging point 28 (see FIG. 5) between merging lane 22 and traveling lane 18 (S202).

In addition, controller 16 determines the predicted position (see FIG. 5) of host vehicle 4 at the predicted merging time based on the current vehicle speed and the current position of host vehicle 4 (S203). Controller 16 determines whether distance D between the predicted position of host vehicle 4 at the predicted merging time and the predicted position (merging point 28) of merging vehicle 24 at the predicted merging time (that is, inter-vehicle distance D between host vehicle 4 and merging vehicle 24 at the predicted merging time) is larger than a predetermined threshold value (S204).

When distance D is larger than the threshold value (YES in S204), controller 16 determines that there is a sufficient inter-vehicle distance between host vehicle 4 and merging vehicle 24 at the predicted merging time, and maintains the vehicle speed of host vehicle 4 (S205). After that, the process proceeds to step S106 of the flowchart in FIG. 2 mentioned above.

On the other hand, in step S204, when distance D described above is smaller than or equal to the threshold value (NO in S204), controller 16 determines that it is necessary to control the traveling of host vehicle because there is no sufficient inter-vehicle distance between host vehicle 4 and merging vehicle 24 at the predicted merging time. In this case, controller 16 determines whether there is another vehicle in overtaking lane 20 based on the target information from radar 8 (S206).

If there is no other vehicle in overtaking lane 20 (NO in S206), controller 16 determines that host vehicle 4 can change lanes from traveling lane 18 to overtaking lane 20. Accordingly, as shown in FIG. 6, controller 16 controls the traveling of host vehicle 4 by controlling steering actuator 15 and the like so that host vehicle 4 changes lanes from traveling lane 18 to overtaking lane 20 (S207). Accordingly, merging vehicle 24 can safely merge into traveling lane 18. After that, the process proceeds to step S106 of the flowchart in FIG. 2 described above.

On the other hand, in step S206, when there is another vehicle in overtaking lane 20 (YES in S206), controller 16 determines that host vehicle 4 cannot change lanes from traveling lane 18 to overtaking lane 20. In this case, controller 16 determines whether host vehicle 4 is in the traveling forward direction of merging vehicle 24 at the predicted merging time based on the positional relationship between the predicted position of host vehicle 4 and merging point 28 determined in step S203 mentioned above (S208).

When host vehicle 4 is in the traveling forward direction of merging vehicle 24 at the predicted merging time (YES in S208), controller 16 increases the vehicle speed of host vehicle 4 by controlling engine actuator 12 (S209). Accordingly, it is possible to secure a sufficient inter-vehicle distance between host vehicle 4 and merging vehicle 24 while host vehicle 4 is traveling in the traveling forward direction of merging vehicle 24 at the predicted merging time. As a result, merging vehicle 24 can safely merge into traveling lane 18. After that, the process proceeds to step S106 of the flowchart in FIG. 2 mentioned above.

On the other hand, in step S208, when host vehicle 4 is in the traveling backward direction (in the retreat direction) of merging vehicle 24 at the predicted merging time (NO in S208), controller 16 reduces the vehicle speed of host vehicle 4 by controlling brake actuator 14 (S210). Accordingly, it is possible to secure a sufficient inter-vehicle distance between host vehicle 4 and merging vehicle 24 while host vehicle 4 is traveling in the traveling backward direction of merging vehicle 24 at the predicted merging time. As a result, merging vehicle 24 can safely merge into traveling lane 18. After that, the process proceeds to step S106 of the flowchart in FIG. 2 mentioned above.

It should be noted that in the present embodiment, when merging lane 22 is detected in the traveling forward direction of host vehicle 4, merging vehicle 24 is detected in merging lane 22, and there is no other vehicle in overtaking lane 20, controller 16 controls the traveling of host vehicle 4 so that host vehicle 4 changes lanes from traveling lane 18 to overtaking lane 20, but it is not limited thereto. For example, when merging lane 22 is detected in the traveling forward direction of host vehicle 4 and there is no other vehicle in overtaking lane 20, controller 16 may control the traveling of host vehicle 4 so that host vehicle 4 changes lanes from traveling lane 18 to overtaking lane 20 regardless of the presence or absence of merging vehicle 24 in merging lane 22.

### [2-2. Operation Example 2]

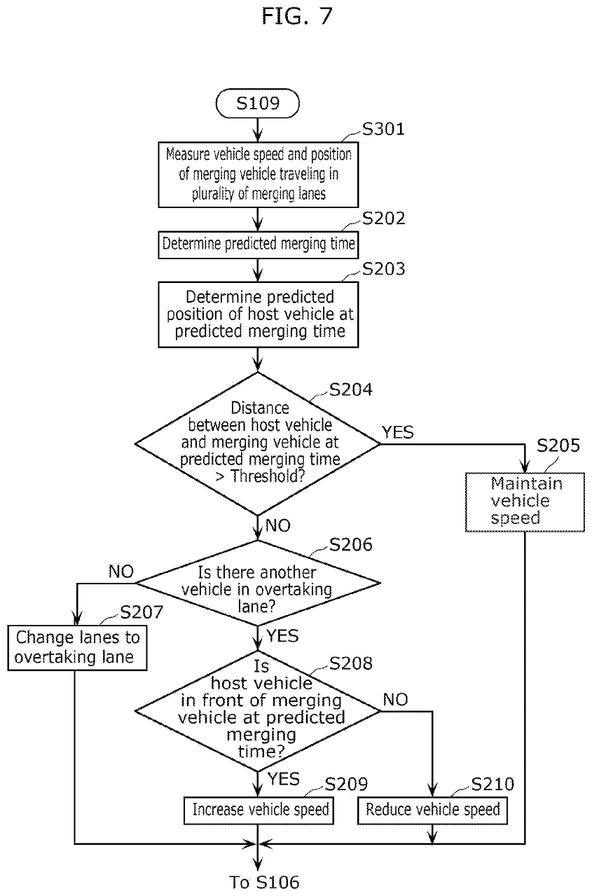

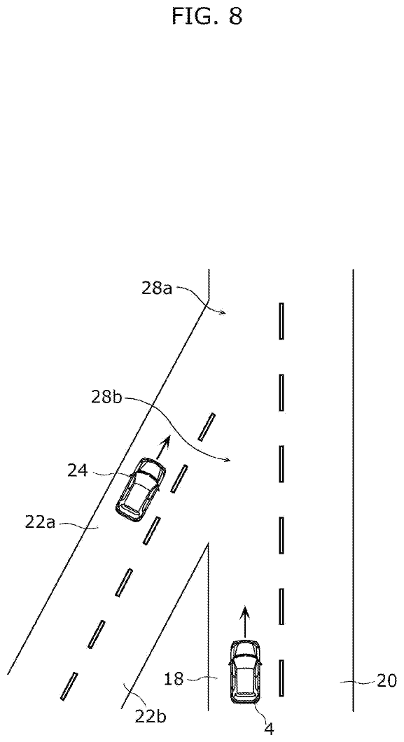

Operation Example 2 of vehicle control system 2 according to the embodiment will be described with reference to FIG. 7 and FIG. 8. FIG. 7 is a flowchart showing a flow of Operation Example 2 of vehicle control system 2 according to the embodiment. FIG. 8 is a diagram for explaining Operation Example 2 of vehicle control system 2 according to the embodiment. It should be noted that in the flowchart of FIG. 7, the same process as the process of the flowchart of FIG. 4 is assigned with the same step number, and the description thereof will be omitted.

In Operation Example 2, as shown in FIG. 8, a situation in which host vehicle 4 is traveling in traveling lane 18 which is the main lane of the expressway by automatic driving will be described. Traveling lane 18 is merged with first merging lane 22a, which is an on-ramp of the expressway, and second merging lane 22b adjacent to the right side of first merging lane 22a. Merging vehicle 24 is traveling in first merging lane 22a.

In addition, in Operation Example 2, controller 16 detects first merging lane 22a and second merging lane 22b in the traveling forward direction of host vehicle 4 based on the image information from camera 6. In addition, controller 16 detects merging vehicle 24 in first merging lane 22a based on the target information from radar 8.

As shown in FIG. 7, controller 16 measures the vehicle speed and position of merging vehicle 24 traveling in a plurality of merging lanes (first merging lane 22a and second merging lane 22b) based on the target information from radar 8 (S301).

Controller 16 determines the predicted merging time that is a time when merging vehicle 24 is predicted to reach merging point 28a (see FIG. 8) between first merging lane 22a and traveling lane 18 based on the measured vehicle speed and position of merging vehicle 24 (S202). It should be noted that in step S202, when merging vehicle 24 is traveling in second merging lane 22b, controller 16 determines the predicted merging time that is a time when merging vehicle 24 is predicted to reach merging place 28b (see FIG. 8) between second merging lane 22b and traveling lane 18 based on the measured vehicle speed and position of merging vehicle 24. Hereinafter, step S203 to step S210 are executed in the same manner as in Operation Example 1 mentioned above.

That is, in Operation Example 2, controller 16 controls the traveling of host vehicle 4 based on merging vehicle 24 traveling in first merging lane 22a or second merging lane 22b so that merging vehicle 24 can merge into traveling lane 18. Accordingly, merging vehicle 24 can safely merge into traveling lane 18.

It should be noted that in Operation Example 2, one merging vehicle 24 travels in first merging lane 22a or second merging lane 22b, but the present disclosure is not limited thereto, and a plurality of merging vehicles 24 may travel in at least one of merging lane 22a or second merging lane 22b.

### [2-3. Operation Example 3]

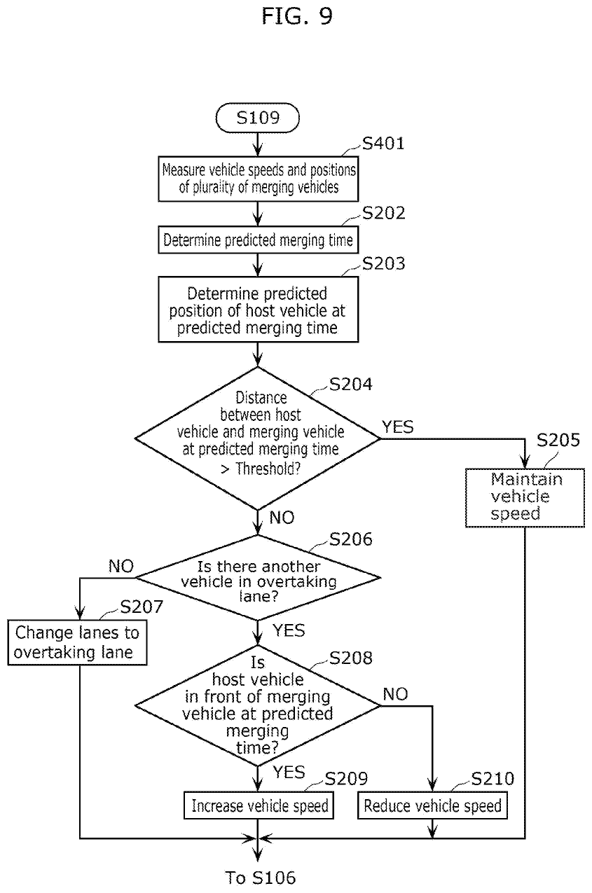

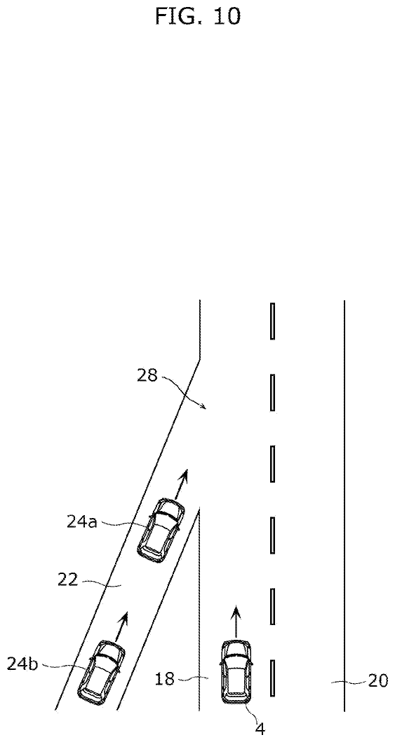

Operation Example 3 of vehicle control system 2 according to the embodiment will be described with reference to FIG. 9 and FIG. 10. FIG. 9 is a flowchart showing a flow of Operation Example 3 of vehicle control system 2 according to the embodiment. FIG. 10 is a diagram for explaining Operation Example 3 of vehicle control system 2 according to the embodiment. It should be noted that in the flowchart in FIG. 9, the same process as the process of the flowchart of FIG. 4 is assigned with the same step number, and the description thereof will be omitted.

In Operation Example 3, as shown in FIG. 10, a situation in which host vehicle 4 is traveling in traveling lane 18 which is the main lane of the expressway by automatic driving will be described. Merging lane 22, which is an on-ramp of the expressway, merges with traveling lane 18. Merging vehicle 24a and merging vehicle 24b that follows merging vehicle 24a are traveling in merging lane 22.

In addition, in Operation Example 3, controller 16 detects merging lane 22 in the traveling forward direction of host vehicle 4 based on the image information from camera 6. In addition, controller 16 detects merging vehicles 24a and 24b in merging lane 22 based on the target information from radar 8.

As shown in FIG. 9, controller 16 measures each vehicle speed and each position of a plurality of merging vehicles (merging vehicles 24a and 24b) traveling in merging lane 22 based on the target information from radar 8 (S401).

Based on each vehicle speed and each position of merging vehicles 24a and 24b that have been measured, controller 16 determines the predicted merging times which are times when merging vehicles 24a and 24b are predicted to reach merging point 28 (see FIG. 10) between merging lane 22 and traveling lane 18, respectively (S202). Hereinafter, step S203 to step S210 are executed in the same manner as in Operation Example 1 mentioned above.

That is, in Operation Example 3, controller 16 controls the traveling of host vehicle 4 based on merging vehicles 24a and 24b so that merging vehicles 24a and 24b can merge into traveling lane 18. Accordingly, merging vehicles 24a and 24b can safely merge into traveling lane 18.

### [2-4. Operation Example 4]

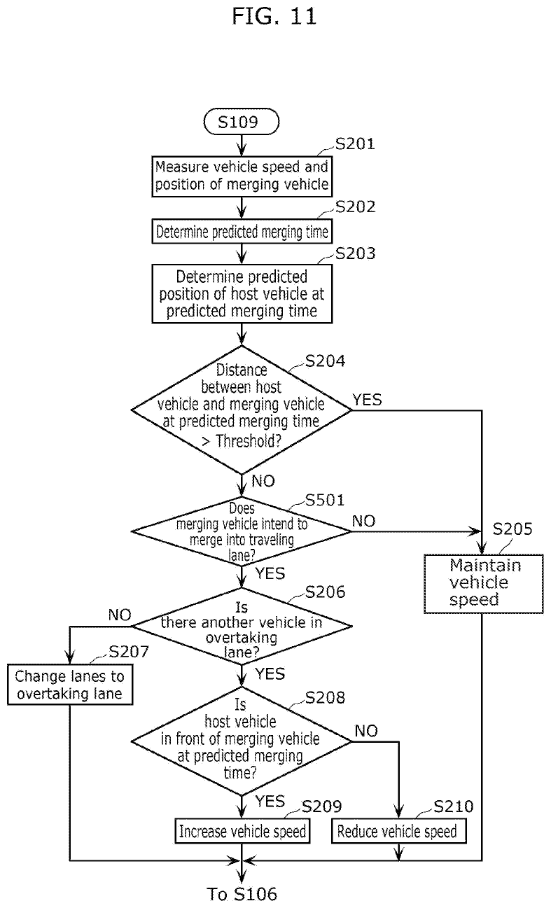

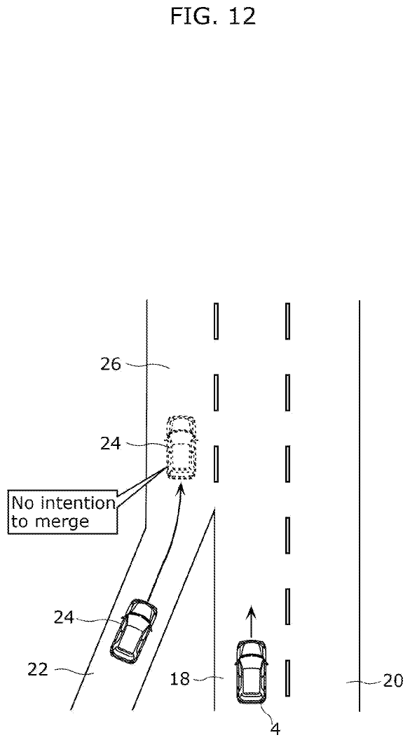

Operation Example 4 of vehicle control system 2 according to the embodiment will be described with reference to FIG. 11 and FIG. 12. FIG. 11 is a flowchart showing a flow of Operation Example 4 of vehicle control system 2 according to the embodiment. FIG. 12 is a diagram for explaining Operation Example 4 of vehicle control system 2 according to the embodiment. It should be noted that in the flowchart in FIG. 11, the same process as the process of the flowchart of FIG. 4 is assigned with the same step number, and the description thereof will be omitted.

In Operation Example 4, as shown in FIG. 12, a situation in which host vehicle 4 is traveling in traveling lane 18 which is the main lane of the expressway by automatic driving will be described. On the left side of traveling lane 18 (opposite to overtaking lane 20), traveling lane 26, which is the main lane of the expressway, is adjacent to traveling lane 18. Merging lane 22, which is an on-ramp on the expressway, merges with traveling lane 18 via traveling lane 26. Merging vehicle 24 is traveling in merging lane 22.

In addition, in Operation Example 4, controller 16 detects merging lane 22 in the traveling forward direction of host vehicle 4 based on the image information from camera 6. In addition, controller 16 detects merging vehicle 24 in merging lane 22 based on the target information from radar 8.

As shown in FIG. 11, first, step S201 to step S204 are executed in the same manner as in Operation Example 1 mentioned above. In step S204, when distance D described above is smaller than or equal to the threshold value (NO in S204), controller 16 determines the presence or absence of an intention of merging vehicle 24 to merge into the traveling lane based on the image information from camera 6 (S501).

When controller 16 detects that the direction indicator of merging vehicle 24 is blinking or the brake lamp is lit based on the image information from camera 6, controller 16 determines that merging vehicle 24 has an intention to merge into traveling lane 18 (YES in S501). In this case, since it is necessary to control the traveling of host vehicle 4 so that merging vehicle 24 can merge into traveling lane 18, the process proceeds to step S206 mentioned above after step S501.

On the other hand, in step S501, when controller 16 detects that the direction indicator of merging vehicle 24 is not blinking and the brake lamp is not lit based on the image information from camera 6, controller 16 determines that merging vehicle 24 has no intention to merge into traveling lane 18 as shown in FIG. 12 (NO in S501). In this case, since it is not necessary to control the traveling of host vehicle 4, the process proceeds to step S205 mentioned above after step S501.

Accordingly, in Operation Example 4, controller 16 can appropriately control the traveling of host vehicle 4 based on the presence or absence of the intention of merging vehicle 24 to merge into traveling lane 18.

### [2-5. Operation Example 5]

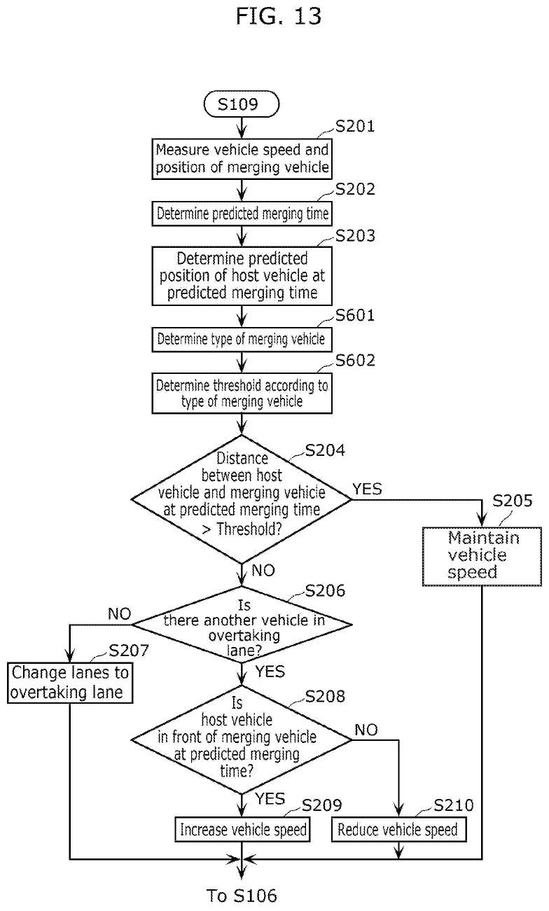

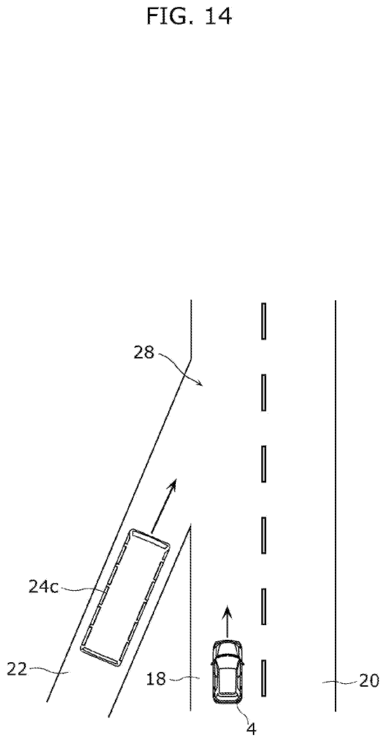

Operation Example 5 of vehicle control system 2 according to the embodiment will be described with reference to FIG. 13 and FIG. 14. FIG. 13 is a flowchart showing a flow of Operation Example 5 of vehicle control system 2 according to the embodiment. FIG. 14 is a diagram for explaining Operation Example 5 of vehicle control system 2 according to the embodiment. It should be noted that in the flowchart of FIG. 13, the same process as the process of the flowchart of FIG. 4 is assigned with the same step number, and the description thereof will be omitted.

In Operation Example 5, as shown in FIG. 14, a situation in which host vehicle 4 which is an ordinary automobile is traveling in traveling lane 18 which is the main lane of the expressway will be described. Merging vehicle 24c, which is a large vehicle such as a bus or a truck, is traveling in merging lane 22.

In addition, in Operation Example 5, controller 16 detects merging lane 22 in the traveling forward direction of host vehicle 4 based on the image information from camera 6. In addition, controller 16 detects merging vehicle 24c in merging lane 22 based on the target information from radar 8.

As shown in FIG. 13, first, step S201 to step S203 are executed in the same manner as in Operation Example 1 mentioned above. After step S203, controller 16 determines the type of merging vehicle 24c based on the image information from camera 6 (S601). Here, the type of vehicle is, for example, a type of automobile defined by the Road Traffic Act, and includes, for example, an ordinary automobile and a large automobile. After that, controller 16 determines a threshold value used in step S204 according to the type of determined merging vehicle 24c (S602). After that, the process proceeds to step S204 mentioned above.

In step S602, for example, when the type of the merging vehicle (not shown) is an ordinary automobile, controller 16 determines a first threshold value as the threshold value. The first threshold value is a threshold value corresponding to a safe inter-vehicle distance between host vehicle 4 which is an ordinary vehicle and the merging vehicle which is an ordinary vehicle at the predicted merging time. For that reason, when distance D described above is larger than the first threshold value, controller 16 determines that there is a sufficient inter-vehicle distance between host vehicle 4 which is an ordinary vehicle and the merging vehicle which is an ordinary vehicle at the predicted merging time.

In addition, in step S602, as shown in FIG. 14, for example, when the type of merging vehicle 24c is a large automobile, controller 16 determines a second threshold value larger than the first threshold value as the threshold value. The second threshold value is a threshold value corresponding to a safe inter-vehicle distance between host vehicle 4 which is an ordinary vehicle and merging vehicle 24c which is a large vehicle at the predicted merging time. For that reason, when distance D described above is larger than the second threshold value, controller 16 determines that there is a sufficient distance between host vehicle 4 which is a normal vehicle and merging vehicle 24c which is a large vehicle at the predicted merging time.

Accordingly, in Operation Example 5, controller 16 can appropriately control the traveling of host vehicle 4 based on the type of merging vehicle 24c.

### [2-6. Operation Example 6]

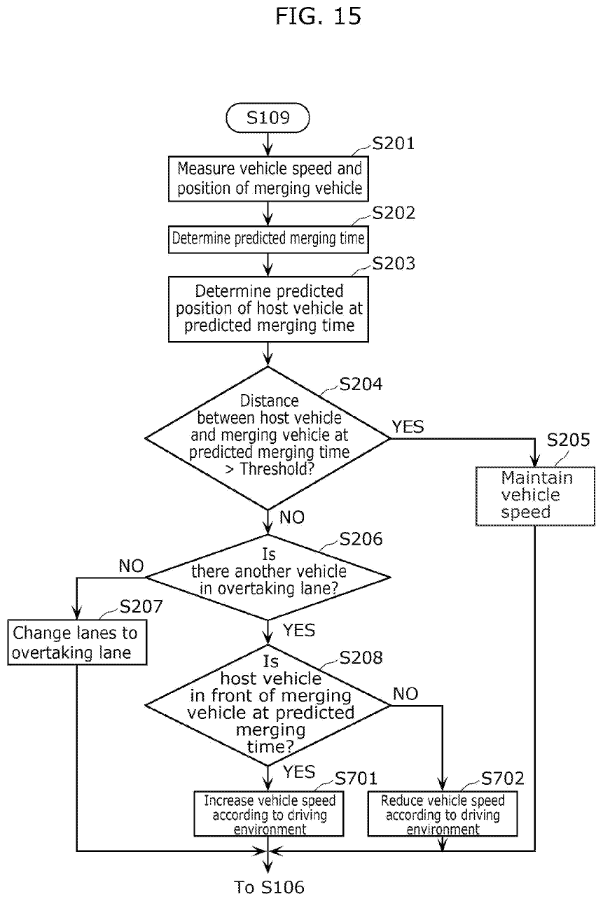

Operation Example 6 of vehicle control system 2 according to the embodiment will be described with reference to FIG. 15. FIG. 15 is a flowchart showing a flow of Operation Example 6 of vehicle control system 2 according to the embodiment. It should be noted that in the flowchart of FIG. 15, the same process as the process of the flowchart of FIG. 4 is assigned with the same step number, and the description thereof will be omitted.

In Operation Example 6, the same situation as in FIG. 3 mentioned above will be described. In addition, in Operation Example 6, controller 16 detects merging lane 22 in the traveling forward direction of host vehicle 4 based on the image information from camera 6. In addition, controller 16 detects merging vehicle 24 in merging lane 22 based on the target information from radar 8.

As shown in FIG. 15, step S201 to step S208 are executed in the same manner as in Operation Example 1 mentioned above. In step S208, when host vehicle 4 is in the traveling forward direction of merging vehicle 24 at the predicted merging time (YES in S208), controller 16 determines the traveling environment (for example, weather, road surface condition, and the like) of host vehicle 4 by analyzing the image information from camera 6, and increases the vehicle speed of host vehicle 4 according to the traveling environment by controlling engine actuator 12 (S701). At this time, for example, when the traveling environment is bad (for example, during heavy rain or snowfall), controller 16 gently increases the vehicle speed of host vehicle 4 so as not to accelerate suddenly.

On the other hand, in step S208, when host vehicle 4 is in the traveling backward direction of merging vehicle 24 at the predicted merging time (NO in S208), controller 16 determines the traveling environment of host vehicle 4 by analyzing the image information from camera 6, and reduces the vehicle speed of host vehicle 4 according to the traveling environment by controlling brake actuator (S702). At this time, for example, when the traveling environment is bad (for example, during heavy rain or snowfall), controller 16 gently reduces the vehicle speed of host vehicle 4 so as not to decelerate suddenly.

Accordingly, in Operation Example 6, controller 16 can appropriately control the traveling of host vehicle 4 based on the traveling environment of host vehicle 4.

### [3. Effect]

As mentioned above, controller 16 controls the traveling of host vehicle 4 so as to change lanes from traveling lane 18 to overtaking lane 20 when merging lane 22 (22a, 22b) is detected. Accordingly, for example, even when merging vehicle 24 (24a, 24b, 24c) merges from merging lane 22 (22a, 22b) into traveling lane 18, it is possible to make host vehicle 4 change lanes at an appropriate timing with a margin. As a result, the traveling safety of host vehicle 4 can be improved.

### (Other Variations)

The vehicle control system according to one or more aspects has been described above based on the above embodiment, but the present disclosure is not limited to the above embodiment. A form obtained by applying various modifications that a person skilled in the art can conceive to each of the above embodiments, and a form constructed by combining the components in different embodiments without departing from the spirit of the present disclosure are also included in the scope of the one or more aspects.

In the above embodiment, vehicle control system 2 is applied to the case where host vehicle 4 travels on the highway, but it is not limited thereto, and vehicle control system 2 may be applied to the case where host vehicle 4 travels on, for example, a bypass road or the like.

It should be noted that in the above embodiment, each component may be configured by dedicated hardware or may be realized by executing a software program suitable for each component. Each component may be realized by a program executor such as a CPU or a processor reading out and executing a software program recorded on a recording medium such as a hard disk or a semiconductor memory.

In addition, a part or all of the functions of the vehicle control system according to the above embodiment may be realized by a processor, such as a CPU, executing a program.

A part or all of the components included in each device described above devices may include an IC card or a single module that can be attached to and detached from each device. The IC card or the module is a computer system including a microprocessor, ROM, RAM, and the like. The IC card or the module may include the super multifunctional LSI described above. The IC card or the module achieves its function by the microprocessor operating according to a computer program. This IC card or this module may have tamper resistance.

The present disclosure may be the method shown above. In addition, it may be a computer program that realizes these methods by a computer, or it may be digital signals including the computer program. In addition, in the present disclosure, the computer program or the digital signals may be recorded on a computer-readable non-temporary recording medium such as a flexible disk, a hard disk, a CD-ROM, an MO, a DVD, a DVD-ROM, a DVD-RAM, or a BD (Blue-ray (registered trademark) Disc), or the like. In addition, the present disclosure may be the digital signals recorded on these recording media. In addition, in the present disclosure, the computer program or the digital signals may be transmitted via a telecommunication line, a wireless or wired communication line, a network typified by the Internet, data broadcasting, or the like. In addition, the present disclosure may be a computer system including a microprocessor and a memory, in which the memory stores the computer program, and the microprocessor is operated according to the computer program. In addition, the present disclosure may be carried out by another independent computer system by recording and transferring the program or the digital signals on the recording medium, or by transferring the program or the digital signal via the network or the like.

While various embodiments have been described herein above, it is to be appreciated that various changes in form and detail may be made without departing from the spirit and scope of the present disclosure as presently or hereafter claimed.

Further Information about Technical Background to this Application

The disclosures of the following patent applications including specification, drawings and claims are incorporated herein by reference in their entirety: Japanese Patent Application No. 2020-212929 filed on Dec. 22, 2020.

### INDUSTRIAL APPLICABILITY

The present disclosure is applicable to, for example, a vehicle control system that controls the traveling of a host vehicle traveling in a main lane of an expressway.

1. A vehicle control system that controls traveling of a host vehicle traveling in a first main lane, the vehicle control system comprising:
a merging lane detector that detects a merging lane that merges with the first main lane, the merging lane existing in front of the host vehicle that is traveling; and
a controller that controls the traveling of the host vehicle to change lanes from the first main lane to a second main lane different from the first main lane when the merging lane is detected by the merging lane detector.

2. The vehicle control system according to claim 1,
wherein the merging lane includes a first merging lane and a second merging lane that is adjacent to the first merging lane,
the vehicle control system further comprises a merging vehicle detector that detects one or more merging vehicles traveling in at least one of the first merging lane or the second merging lane, and
the controller further controls the traveling of the host vehicle to allow the one or more merging vehicles to merge into the first main lane based on a detection result of the merging vehicle detector.

3. The vehicle control system according to claim 1, further comprising:
a merging vehicle detector that detects a merging vehicle traveling in the merging lane,
wherein when a plurality of the merging vehicles are detected by the merging vehicle detector, the controller further controls the traveling of the host vehicle so that the plurality of merging vehicles are capable of merging in the first main lane based on a detection result of the merging vehicle detector.

4. The vehicle control system according to claim 1, further comprising:
a merging vehicle detector that detects a merging vehicle traveling in the merging lane,
wherein the controller further determines whether the merging vehicle intends to merge into the first main lane based on a detection result of the merging vehicle detector, and controls the traveling of the host vehicle based on a result of determining whether the merging vehicle intends to merge.

5. The vehicle control system according to claim 1, further comprising:
a merging vehicle detector that detects a merging vehicle traveling in the merging lane,
wherein the controller further determines a type of the merging vehicle based on a detection result of the merging vehicle detector, and controls the traveling of the host vehicle so that the merging vehicle is capable of merging in the first main lane based on the type of the merging vehicle determined.

6. The vehicle control system according to claim 1, further comprising:
a traveling environment detector that detects a traveling environment of the host vehicle,
wherein the controller further controls the traveling of the host vehicle based on a detection result of the traveling environment detector.

7. The vehicle control system according to claim 2,
wherein the controller determines whether the host vehicle is in front of the merging vehicle that is traveling at a predicted merging time when the merging vehicle is predicted to reach a merging point of the merging lane and the first main lane, and increases a vehicle speed of the host vehicle when the host vehicle is in front of the merging vehicle that is traveling.

8. The vehicle control system according to claim 2,
wherein the controller determines whether the host vehicle is in front of the merging vehicle that is traveling at a predicted merging time when the merging vehicle is predicted to reach a merging point of the merging lane and the first main lane, and reduces a vehicle speed of the host vehicle when the host vehicle is behind the merging vehicle that is traveling.

9. A vehicle control method for controlling traveling of a host vehicle traveling in a first main lane, the vehicle control method comprising:
detecting a merging lane existing in front of the host vehicle that is traveling and merging with the first main lane, and
controlling the traveling of the host vehicle to change lanes from the first main lane to a second main lane different from the first main lane when the merging lane is detected in the detecting.
